(19) United States
(12) Patent Application Publication
(10) Pub. No.: US 2013/0347109 A1
(43) Pub. Date: Dec. 26, 2013

(54) Techniques for Detecting Program Modifications

(71) Applicant: Scott Fluhrer, North Attleboro, MA (US)

(72) Inventor: Scott Fluhrer, North Attleboro, MA (US)

(73) Assignee: CISCO TECHNOLOGY, INC., San Jose, CA (US)

(21) Appl. No.: 13/529,068

(22) Filed: Jun. 21, 2012

(51) Int. Cl. G06F 21/24

(52) U.S. Cl. 726/23

(57) ABSTRACT

Techniques are provided for detecting modifications to software instructions. At a computing apparatus configured to execute a software program comprising a plurality of instructions, at least a first check point having a first check value and a second check point having a second check value are assigned within the instructions. At least first and second portions of the instructions are identified. The first portion of the instructions comprises one or more check points other than the first check point. The second portion of the instructions comprises one or more check points other than the second check point. A first hashing operation is performed over the first portion resulting in a first equation and a second hashing operation is performed over the second portion resulting in a second equation. The first check value and the second check value are computed based on the first equation and the second equation.

### TECHNICAL FIELD

The present disclosure relates to evaluating software code for purposes of tampering detection.

### BACKGROUND

Physical local area networks (LANs) are networks of physical network devices located within a same local area. A physical server of the LAN may be configured to host a plurality of virtual devices arranged in a virtual LAN (VLAN). For example, the physical server of the LAN may host a plurality of virtual machines configured to communicate with a virtual switch in the VLAN. One or more of the virtual machines may run a software program comprised of processor instructions. The processor instructions may comprise software to direct processor operations for physical devices in the LAN. A third party/malicious entity may modify or tamper with the software program, thus compromising the security of data transferred in network.

### BRIEF DESCRIPTION OF THE DRAWINGS

FIG. 1 shows an example system topology including a plurality of client devices and a physical server configured to host a plurality of virtual devices.

FIG. 2 shows an example of the physical server configured to host the plurality of virtual devices and to detect modifications to software instructions of the virtual devices.

FIG. 3 illustrates an example graphical representation of regions of the software instructions that are checked in order to detect potential modifications to the software instructions.

FIG. 4 illustrates a depiction of data fields of a database that stores detection information and corresponding regions of the software instructions associated with the detection information.

FIG. 5 shows an example scenario of the tampering detection process in detecting a modification of the software instructions.

FIG. 6 shows an example flow chart depicting operations performed by the physical server to detect modifications to software instructions.

### DESCRIPTION OF EXAMPLE EMBODIMENTS

### Overview

Techniques are provided for detecting modifications to software instructions. These techniques may be embodied as a method, apparatus and instructions in a computer-readable storage media to perform the method. At a computing apparatus configured to execute a software program comprising a plurality of instructions, at least a first check point having a first check value and a second check point having a second check value are assigned within the instructions. At least first and second portions of the instructions are identified. The first portion of the instructions comprises one or more check points other than the first check point. The second portion of the instructions comprises one or more check points other than the second check point. A first hashing operation is performed over the first portion resulting in a first equation and a second hashing operation is performed over the second portion resulting in a second equation. The first check value and the second check value are computed based on the first equation and the second equation.

### Example Embodiments

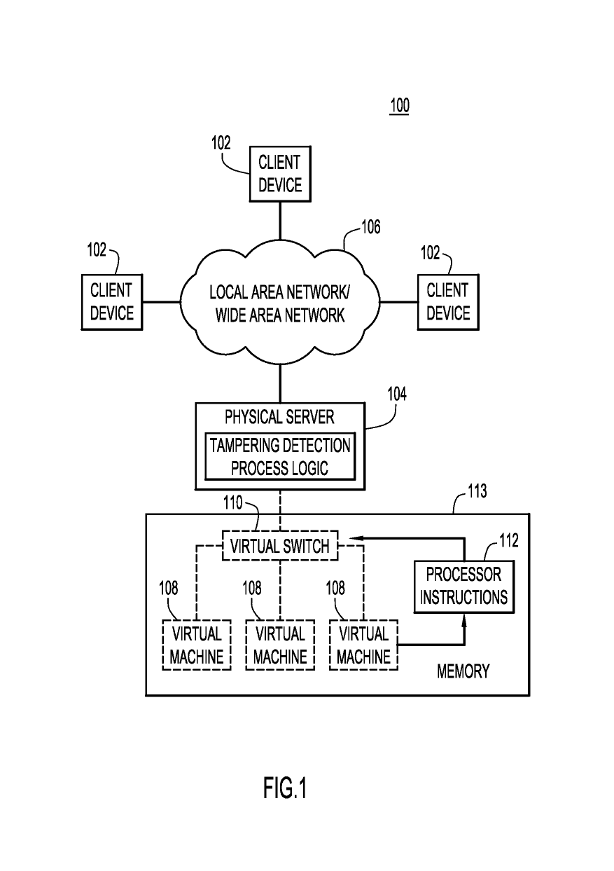

The techniques described herein are directed to evaluating regions of software instructions to determine if unauthorized modifications have been made to the software. The software instructions may, for example, be part of a software program associated with one or more virtual devices hosted by a physical server. An example system/topology 100 is illustrated in FIG. 1. The topology 100 comprises a plurality of client devices 102 and a physical server 104. The client devices 102 and the physical server 104 (the physical server 104 is also referred to herein as a “computing apparatus”) are configured to send and receive data communications (e.g., data packets) to each other across a network. For example, the client devices 102 and the physical server 104 are in communication with each other over a local area network (LAN)/wide area network (WAN) 106.

The topology 100 may also comprise a plurality of “virtual” devices. These virtual devices may be hosted by hardware or software components of the physical server 104. For example, the physical server may host a plurality of virtual machines 108 in communication with a virtual switch 110 such that the virtual machines 108 and the virtual switch 110 are able to communicate with each other within a virtual LAN (VLAN) or virtual WAN (VWAN). The virtual machines 108, virtual switch 110 and processor instructions 112 may reside in a memory 113. It should be appreciated that although topology 100 shows one physical server hosting the virtual machines 108 and the virtual switch 110, any number of physical servers may be present in topology 100 to host any number of virtual devices in a plurality of VLANs/VWANs. For simplicity, FIG. 1 depicts the virtual devices with dotted or dashed lines, while the physical devices are depicted with solid lines.

The virtual machines 108 may be accessible by one or more of the client devices 102 via the physical server 104. The client devices 102 may be any one of web-enabled computing devices, mobile devices, laptops, tablets, televisions, etc., that are configured to access resources and services (e.g., software-as-a-service (SaaS), infrastructure-as-a-service (IaaS), etc.) hosted by one or more of the virtual machines 108 via the physical server 104. The virtual machines 108 may run software programs, e.g., on software or hardware components of the physical server 104 and as shown in FIG. 1, the software programs of the virtual machines 108 may comprise processor instructions (e.g., an “image”) to instruct processor components of other devices (physical or virtual) in topology 100. An example of the processor instructions is shown at reference numeral 112 in topology 100. Additionally, other virtual devices (e.g., the virtual switch 110) may also run these software programs. As described herein, the physical server 104 can analyze software code of the processor instructions 112, for example, to determine whether the instructions have been tampered with or modified. It should be appreciated that while the physical server 104 runs the processor instructions to instruct processor components of the virtual devices in topology 100, the determination of whether the instructions have been tampered with or modified is made by processor components of the virtual devices themselves.

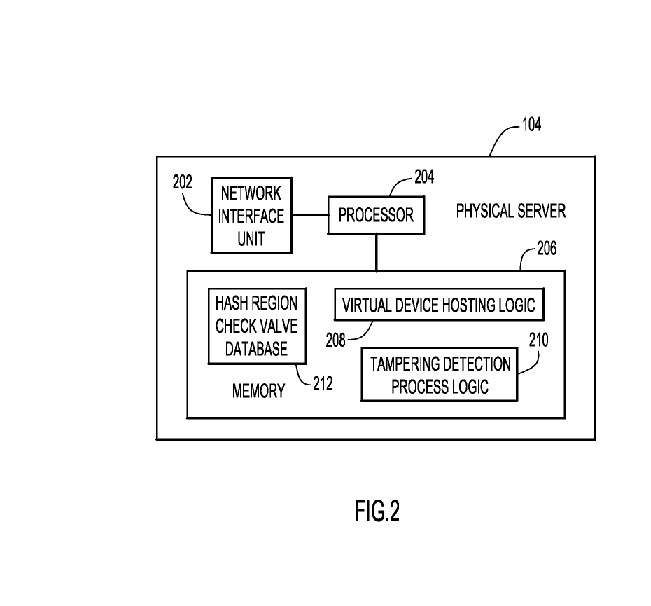

Reference is now made to FIG. 2. FIG. 2 shows a block diagram of the physical server 104. The physical server 104 comprises, among other components, a network interface unit 202, a processor 204 and a memory 206. The network interface unit 202 is configured to receive communications (e.g., data packets) sent across the LAN/WAN 106 from the client devices and to send communications from the physical server 104 across the LAN/WAN 106. The network interface unit 202 is coupled to the processor 204. The processor 204 is, for example, a microprocessor or microcontroller that is configured to execute program logic instructions (i.e., software) for carrying out various operations and tasks of the physical server 104, as described herein. For example, the processor 204 is configured to execute virtual device hosting logic 208 to host virtual devices (e.g., the virtual machines 108 and the virtual switch 110) and tampering detection process logic 210 to analyze instructions of the virtual devices in order to detect any modifications or tampering of the instructions. The functions of the processor 204 may be implemented by logic encoded in one or more tangible computer readable storage media or devices (e.g., storage devices compact discs, digital video discs, flash memory drives, etc. and embedded logic such as an application specific integrated circuit, digital signal processor instructions, software that is executed by a processor, etc.).

The memory 206 may comprise read only memory (ROM), random access memory (RAM), magnetic disk storage media devices, optical storage media devices, flash memory devices, electrical, optical, or other physical/tangible (non-transitory) memory storage devices. The memory 206 stores software instructions for the virtual device hosting logic 208 and the tampering detection process logic 210. The memory 206 may also host a hash region check value database (“database) 212 that stores, for example, designated hash regions of the instructions and corresponding reference or “check” values for the hash regions, as described by the techniques herein. Thus, in general, the memory 206 may comprise one or more computer readable storage media (e.g., a memory storage device) encoded with software comprising computer executable instructions and when the software is executed (e.g., by the processor 204) it is operable to perform the operations described for the virtual machines hosting logic 208 and the tampering detection process logic 210.

The virtual device hosting logic 208 and the tampering detection process logic 210 may take any of a variety of forms, so as to be encoded in one or more tangible computer readable memory media or storage device for execution, such as fixed logic or programmable logic (e.g., software/computer instructions executed by a processor), and the processor 204 may be an application specific integrated circuit (ASIC) that comprises fixed digital logic, or a combination thereof.

For example, the processor 204 may be embodied by digital logic gates in a fixed or programmable digital logic integrated circuit, which digital logic gates are configured to perform the virtual device hosting logic 208 and the tampering detection process logic 210. In general, the virtual device hosting logic 208 and the tampering detection process logic 210 may be embodied in one or more computer readable storage media encoded with software comprising computer executable instructions and when the software is executed operable to perform the operations described hereinafter.

In general, a user of one of the client devices 102 (e.g., a computer) in topology 100 may attempt to access content or services provided by one or more of the virtual machines 108. For example, the user of one of the client devices 102 may remotely access SaaS services provided by one or more of the virtual machines 108 via the LAN/WAN 106 and the physical server 104. Accordingly, the virtual machines 108 may need to send processor instructions 112 to one or more devices in topology 100 to manage the communications with the client devices 102.

As described above, the virtual machines 108 are hosted by the physical server 104, and the virtual machines 108 may be configured with software programs comprising the processor instructions 112 to instruct or control processor operations of other devices/components in topology 100. Often, however, these processor instructions may be subject to possible tampering. For example, a third party not shown in topology 100 may gain unauthorized access to the virtual machines 108 (e.g., via the physical server 104) and may modify the software code of the processor instructions 112 for malicious or snooping purposes. The resulting modifications may be harmful to the devices in topology 100 or may extract personal information from users of the client devices 102. Thus, according to the techniques described herein, the physical server 104 is configured to perform hashing operations on portions of the software code of the processor instructions 112 in order to detect whether or not the processor instructions 112 have been tampered with or modified.

Conventional tamper detection techniques involve running a variety of check routines on software code of the processing instructions. For example, while the processor instructions are running, the existing techniques periodically run a check routine to generate a checksum value (e.g., numerical value) for a portion of the software code. The checksum value is then compared to a known “good” check value for the portion of the code. The known good check value is often stored in a database. When an attacker accesses the database and modifies a known good check value, these techniques may be ineffective in detecting modifications to the software code. For example, by modifying the known good check value, the attacker can then modify the portion of the software code corresponding to the good check value such that the check routine returns a checksum value that is the same as the check value that the attacker modified. Thus, the check routine of the conventional techniques will incorrectly cause a physical server to indicate or “believe” that the software code has not been modified.

To avoid this problem, the tampering detection process logic 210 of the physical server 104 performs a series of check routines on different portions of the software code to obtain a corresponding series of interdependent check values, as described herein. Modifications to one or more of these different portions of the software code may result in corresponding modifications to all of the check values. Thus, an attacker having access to a database storing known good check values cannot simply modify these check values and corresponding portions of the software code without the modification being detected. These techniques are described in detail hereinafter.

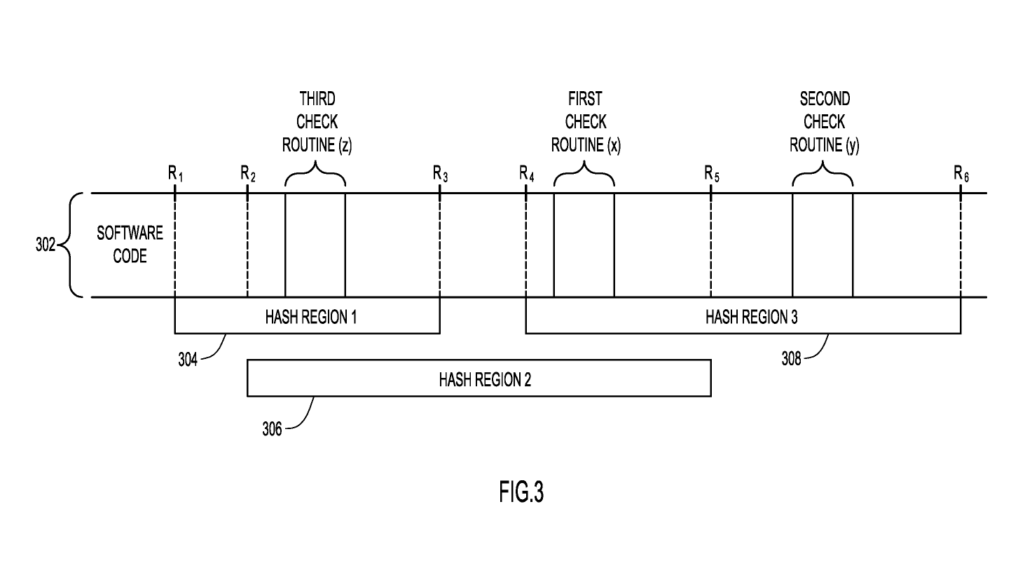

Reference is now made to FIG. 3, which shows an example representation of regions/portions of the software code of the processor instructions 112 that are checked to detect potential modifications to the software code. In FIG. 3, the software code is depicted at reference numeral 302. The software code 302 may, for example, represent object-oriented software code, pseudocode, compiled software code, etc., that is executed to run the processor instructions 112. FIG. 3 also shows a plurality of reference points in the software code, labeled R₁-R₆. The software code 302 is divided into a plurality of regions (“hash regions”). For example, FIG. 3 shows three hash regions: hash region 1 (shown at reference numeral 304), hash region 2 (shown at reference numeral 306) and hash region 3 (shown at reference numeral 308). Hash region 1 represents a region or segment of the software code 302 between reference point R₁ and reference point R₃. Hash region 2 represents a region or segment of the software code 302 between reference point R₂ and reference point R₅. Hash region 3 represents a region or segment of the software code 302 between reference point R₄ and reference point R₆. Hash region 1 may cover a first portion of the software code 302 (e.g., “words” or “lines” of the software code), hash region 2 may cover a second portion of the software code 302, and so on. Though FIG. 3 shows three hash regions, it should be appreciated that the physical server 104 may use any number of hash regions at any given length to determine whether or not the software code 302 has been modified by the techniques herein. Additionally, the hash regions may be contiguous portions of the software code (e.g., “words” or “lines” of the software code 302 that are continuous between hash regions) or may be non-contiguous (e.g., “words” or “lines” of the software code 302 that are non-continuous between hash regions).

As stated above, while the physical server 104 runs the processor instructions to instruct processor components of the virtual devices in topology 100, the determination of whether the instructions have been tampered with or modified is made by processor components of the virtual devices themselves. With this understanding, the physical server 104 is described as performing various aspects of the techniques described herein. For example, the physical server 104 evaluates or tests the software code 302 located in the hash regions to determine whether or not the software code 302 has been modified. For example, the physical server 104 performs a hashing/checksum operation on each of the hash regions to generate a numerical representation of each of the hash regions and to determine corresponding check routine values (“check values”) associated with the hash regions. That is, to determine the check value associated with hash region 1 (shown as a first check routine or check value “x” at a first check point in FIG. 3), the physical server 104 checks (e.g., by performing a hashing/checksum operation) the software code 302 between reference points R₁ and reference point R₃ and computes a corresponding first check value. Similarly, the physical server 104 determines the check value associated with hash region 2 (shown as a second check routine or check value “y” at a second check point) by checking the software code 302 between reference points R₂ and R₅ and computing a second check value. The physical server 104 determines the check value associated with hash region 3 (shown as a third check routine or check value “z” at a third check point) by checking the software code 302 between reference points R₄ and R₆ and computes a third check value. The check values for each of the hash regions are stored in the hash region check value database 212 in memory 206 of the physical server 104.

As shown in FIG. 3, each of the check values x, y and z are interrelated. For example, in order to determine the check value x, the hashing/checksum operation is performed on the hash region 1 of the software code 302, which includes the check value z. Similarly, in order to determine the check value y, the hashing/checksum operation is performed on the hash region 2 of the software code 302, which includes check value z and check value x. In order to determine the check value z, the hashing/checksum operation is performed on the hash region 3 of the software code, which includes the check value x and check value y. Thus, since all of the check values are interdependent, any modification to a single check value or a single hash region of the software code results in modification of all of the check values. For example, if an attacker were to gain access to the hash region check value database 212 that stores the check values x, y and z the attacker could not simply modify the check value x and corresponding hash region 1 of the software code 302, since a modification to the check value x would subsequently modify the other check values y and z. Thus, any modification to the software code 302 would require changing each and every interdependent check value in the hash region check value database 212. When the physical server 104 performs a large number of check operations (e.g., using a large number of hash regions), an attacker will unlikely be able to modify each of the interdependent check values accurately for the corresponding modifications to go undetected. As a result, the interdependence of the check value calculation makes it more difficult for a third party to modify the software code 302 without being detected. Additionally, the physical server 104 can easily detect when a modification has occurred by determining whether a single check value is different from a corresponding stored reference or expected check value.

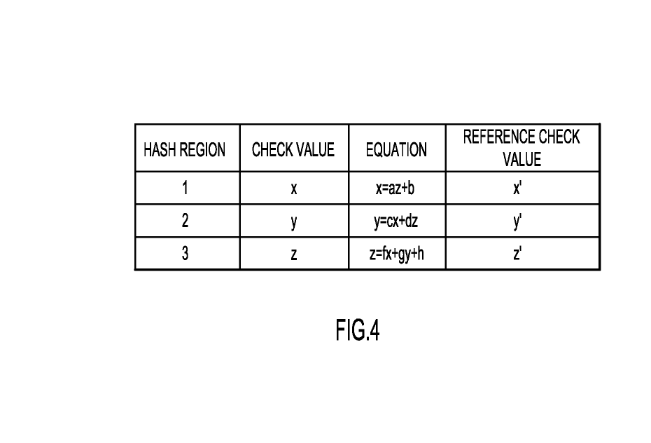

Reference is now made to FIG. 4, which shows an example depiction of data fields of the hash region check value database 212. As stated above, the hash region check value database 212 is configured to store detection information (e.g., check values) for hash regions of the software code 302. Additionally, the hash region check value database 212 is configured to store expected check values (also referred to as “stored check values”) for the hash regions. The check values are depicted in FIG. 4 as values x, y and z and the expected check values are depicted in FIG. 4 as x′, y′ and z′.

As stated above, since the check values corresponding to the hash regions are interdependent, a set of linear equations may be generated to calculate these check values. For example, FIG. 4 shows three check values (x, y and z) to be calculated from three corresponding linear equations (where a, b, c, d, f, g and h represent constant values). These linear equations are solvable to determine the check values since the number of linear equations is equal to the number of unknown variables (e.g., three linear equations to solve three unknown values x, y and z). The linear equations depicted in FIG. 4 mirror the example provided in FIG. 3, where check value x is dependent on check value z, check value y is dependent on check value x and check value z and check value z is dependent on check value x and check value y. It should be appreciated, however, that these check values may be interdependent in other ways and that any number of check values and corresponding hash regions with any combination of interdependencies may be used. In the example in FIG. 4, the linear equations show that a change in the check value x results in a change in check values y and z, a change in check value y results in a change in check value z, and a change in check value z results in a change in check values x and y.

The physical server 104 can compare these calculated check values x, y and z to predetermined stored check values to determine whether or not the calculated check values match the stored reference check values. The stored check values may be based on initial acceptable check values that, for example, may be stored in the hash region check value database 212 during an initial evaluation of the software code 302, at a time when the software code 302 has been determined to be “safe” or unmodified, by a network administrator who monitors the software code 302, etc. In one embodiment, when at least one of the calculated check values does not match its corresponding predetermined stored check value, the physical server 104 may determine that the processor instructions 112 have been tampered with or modified and may take an appropriate action (e.g., disabling the processor instructions 112, alerting a network administrator of the modified software code 302, etc.). If all of the calculated check values match corresponding predetermined stored check values, the physical server 104 may determine that the processing instructions 112 have not been tampered with or modified. Accordingly, the physical server 104 may repeat the evaluation of the hash regions after a predetermine amount of time to update the stored reference check values that may be used for subsequent analysis of the software code 302.

In one embodiment, the physical server 104 may select hash regions in the software code 302 and may insert or deposit default check values in each of the hash regions. For each of the hash regions, a corresponding check value can be determined as a function of other check values within the particular hash region. As stated above, it should be appreciated that any number of hash regions may be designated in the software code 302. In one example, the software code 302 may be divided into 100 hash regions and 100 checks may be assigned to check each of the 100 hash regions. By increasing the number of hash regions and associated check values, the software code 302 may be further protected from any code modification going undetected by the physical server 104.

There may be many possible methods to generate the linear equations. For example, linear equations may be generated according to one or more of the following techniques: linear over addition in a Galois field of two elements (GF(2)); linear over addition modulo N, for some value N (e.g., if N=256, a “hash” may be the sum of the bytes within the check region, ignoring overflow); and linear over arithmetic in a Galois field with pⁿ (GF(pⁿ)) elements (e.g., where ‘p’ is a prime number and ‘n’ is an integer). Additionally, it should be appreciated that the hash regions may be nonconsecutive hash regions. In one example, hash regions might consist of a “word 7”, “word 7+97,” “word 7+2*97,”. . . , “word 7+n*97” (for any integer n). Using nonconsecutive hash regions may be advantageous in that an outside party would have to modify multiple check regions throughout the software code 302 in order to avoid detection.

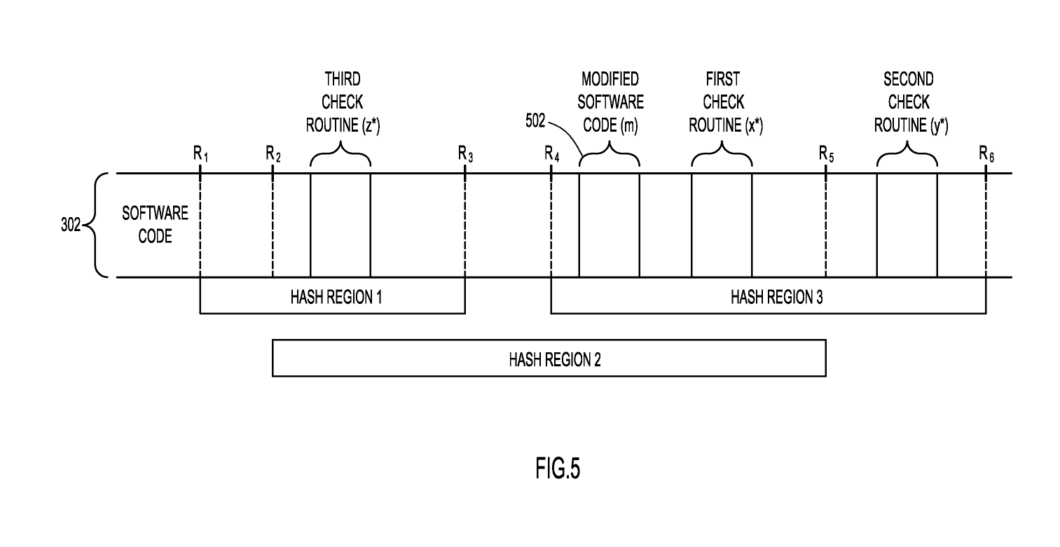

Reference is now made to FIG. 5, which shows an example of the physical server 104 detecting that a modification or tampering in the software code 302 has occurred. In FIG. 5, the software code 302 has three hash regions similar to those described above in connection with FIG. 3. FIG. 5 also shows a modified portion “m” of the software code at reference numeral 502. For example, the modified portion 502 of the software code 302 may represent malicious changes to the code made by a third party attacker. As shown in FIG. 5, the modified portion 502 is located between reference point R₄ and reference points R₅ and R₆. Thus, in this example, the modified portion 502 is located in both hash region 2 and hash region 3. When the physical server 104 performs the hashing/checksum operation on the hash region 2, the corresponding check value for hash region 2 (shown as y* in FIG. 5) will be modified, since the hash region 2 contains the modified portion 502 of the software code 302. As a result, hash region 3 now comprises both the modified portion 502 and the modified check value y*; accordingly, the corresponding check value for hash region 3 (shown as z*) will also be modified. Since z* is located in hash region 1, the corresponding check value for hash region 1 (shown as x*) will also be modified, even though hash region 1 of the software code 302 does not contain the modified portion 502.

Thus, when the physical server 104 compares the modified check values (also referred to as “modified check values”) x*, y* and z* with the stored check values, the physical server 104 will determine that the software code 302 has been modified since there is at least one modified check value that will not match its corresponding stored check values (x′, y′ and z′ in FIG. 4). The physical server 104 may determine that software code 302 has been modified when any of the modified check values does not match its corresponding stored check value. For example, the physical server 104 will detect a modification when check value x* (associated with hash region 1) does not match the stored check value x′ for hash region 1, even though the code in hash region 1 has not been modified. This interdependence of check values decreases the likelihood that modifications to the software code 302 will remain undetected by the physical server 104. Additionally, by utilizing linear, interdependent check values, the software code 302 does not have to rely on processing intensive cryptographic hashes.

In one example, as a part of the process of building the software, the physical server 104 selects areas of the software code 302 to hash, inserts check routines into the software code, computes the linear equations, solves the linear equations and then inserts the check values into the check routines. These operations are performed, for example, in an area safe from an outside party. Then, when the software code 302 is running, the check routines are executed and each one of the check routines checks the assigned or corresponding hash region of the software code 302.

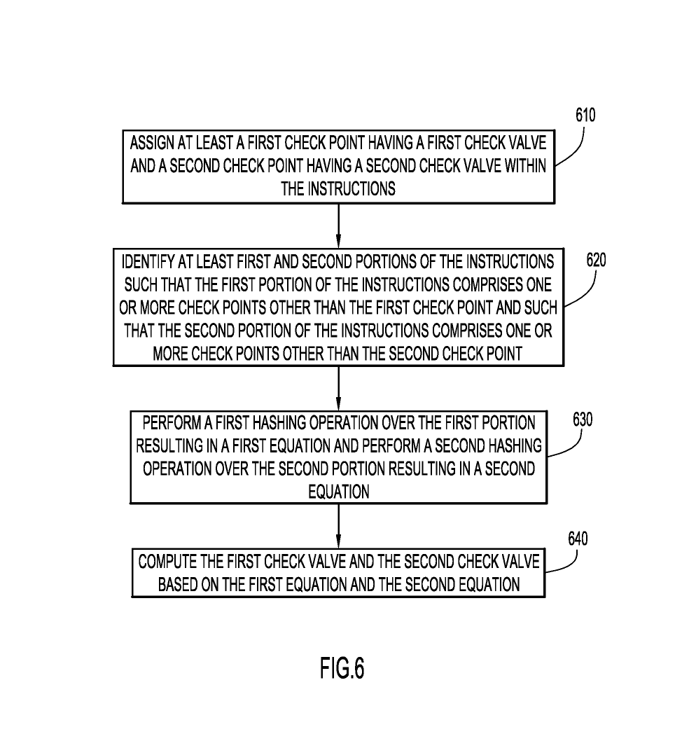

Reference is now made to FIG. 6. FIG. 6 shows an example flow chart 600 depicting operations performed by the tampering detection process logic 210 of the physical server 104 to detect modifications to the software code 302. At operation 610, the physical server 104 assigns at least a first check point having a first check value and a second check point having a second check value within the processor instructions 112 (e.g., the software code 302 of the processor instructions. At operation 620, the physical server 104 identifiers at least first and second portions (e.g., hash regions) of the instructions such that the first portion of the instructions comprises one or more check points other than the first check point and such that the second portion of the instructions comprises one or more check points other than the second check point. The physical server 104, at operation 630, then performs a first hashing/checksum operation over the first portion resulting in a first equation and performs a second hashing/checksum operation over the second portion resulting in a second equation. The first check value and the second check value are computed, at operation 640, based on the first equation and the second equation.

It should be appreciated that the techniques described above in connection with all embodiments may be performed by one or more computer readable storage media that is encoded with software comprising computer executable instructions to perform the methods and steps described herein. For example, the operations performed by the physical server 104 may be performed by one or more computer or machine readable storage media (non-transitory) or device executed by a processor and comprising software, hardware or a combination of software and hardware to perform the techniques described herein.

In sum, a method is provided comprising: at a computing apparatus configured to execute a software program comprising a plurality of instructions, assigning at least a first check point having a first check value and a second check point having a second check value within the instructions; identifying at least first and second portions of the instructions such that the first portion of the instructions comprises one or more check points other than the first check point and such that the second portion of the instructions comprises one or more check points other than the second check point; performing a first hashing operation over the first portion resulting in a first equation and performing a second hashing operation over the second portion resulting in a second equation; and computing the first check value and the second check value based on the first equation and the second equation.

In addition, one or more computer readable storage media encoded with software is provided comprising computer executable instructions and when the software is executed operable to: assign at least a first check point having a first check value and a second check point having a second check value within a plurality of instructions of a computing apparatus configured to execute a software program; identify at least first and second portions of the instructions such that the first portion of the instructions comprises one or more check points other than the first check point and such that the second portion of the instructions comprises one or more check points other than the second check point; perform a first hashing operation over the first portion resulting in a first equation and perform a second hashing operation over the second portion resulting in a second equation; and compute the first check value and the second check value based on the first equation and the second equation.

Furthermore, an apparatus is provided comprising: a network interface unit; a memory; and a processor coupled to the network interface unit and the memory and configured to: assign at least a first check point having a first check value and a second check point having a second check value a plurality of check points within a plurality of instructions of a software program; identify at least first and second portions of the instructions such that the first portion of the instructions comprises one or more check points other than the first check point and such that the second portion of the instructions comprises one or more check points other than the second check point; perform a first hashing operation over the first portion resulting in a first equation and perform a second hashing operation over the second portion resulting in a second equation; compute the first check value and the second check value based on the first equation and the second equation.

The above description is intended by way of example only. Various modifications and structural changes may be made therein without departing from the scope of the concepts described herein and within the scope and range of equivalents of the claims.

What is claimed is:

1. A method comprising:
at a computing apparatus configured to execute a software program comprising a plurality of instructions, assigning at least a first check point having a first check value and a second check point having a second check value within the instructions;
identifying at least first and second portions of the instructions such that the first portion of the instructions comprises one or more check points other than the first check point and such that the second portion of the instructions comprises one or more check points other than the second check point;
performing a first hashing operation over the first portion resulting in a first equation and performing a second hashing operation over the second portion resulting in a second equation; and
computing the first check value and the second check value based on the first equation and the second equation.

2. The method of claim 1, further comprising:
comparing the first check value with a predetermined stored first check value and comparing the second check value with a predetermined stored second check value to generate comparison results; and
determining that the instructions have been tampered with when the comparison results indicate that either the first check value does not match the predetermined stored first check value or the second check value does not match the predetermined stored second check value.

3. The method of claim 2, further comprising determining the first predetermined stored check value based on an initial acceptable first checksum value and the second predetermined stored check value based on an initial acceptable second checksum value.

4. The method of claim 1, wherein performing the first hashing operation and the second hashing operation comprises performing the first hashing operation and the second hashing operation such that a change in the first check value results in a corresponding change in the second check value and a change in the second check value results in a corresponding change in the first check value.

5. The method of claim 1, wherein computing the first check value and the second check value comprises computing the first check value and the second check value by solving a set of linear equations comprising the first equation and the second equation.

6. The method of claim 5, wherein computing comprises computing the first check value and the second check value by solving the set of linear equations, wherein the first equation and the second equation are dependent upon one another.

7. The method of claim 5, wherein computing comprises computing the first check value and the second check value by solving the set of linear equations that are generated according to one of the following techniques: linear over addition in a Galois field of two elements (GF(2)), linear over addition modulo N, and linear over arithmetic in a Galois field with pⁿ elements (GF(pⁿ)).

8. The method of claim 1, further comprising repeating the computing of the first check value and the second check value after a predetermined amount of time to produce an updated first check value and an updated second check value.

9. The method of claim 1, wherein identifying comprises identifying the first portion of the instructions that is nonconsecutive with the second portion of the instructions.

10. One or more computer readable storage media encoded with software comprising computer executable instructions and when the software is executed operable to:
assign at least a first check point having a first check value and a second check point having a second check value within a plurality of instructions of a computing apparatus configured to execute a software program;
identify at least first and second portions of the instructions such that the first portion of the instructions comprises one or more check points other than the first check point and such that the second portion of the instructions comprises one or more check points other than the second check point;
perform a first hashing operation over the first portion resulting in a first equation and perform a second hashing operation over the second portion resulting in a second equation; and
compute the first check value and the second check value based on the first equation and the second equation.

11. The computer readable storage media of claim 10, further comprising instructions operable to:
compare the first check value with a predetermined stored first check value and compare the second check value with a predetermined stored second check value to generate comparison results; and
determine that the instructions have been tampered with when the comparison results indicate that either the first check value does not match the predetermined stored first check value or the second check value does not match the predetermined stored second check value.

12. The computer readable storage media of claim 11, further comprising instructions operable to determine the first predetermined stored check value based on an initial acceptable checksum value and the second predetermined stored check value based on an initial acceptable second checksum value.

13. The computer readable storage media of claim 10, wherein the instructions operable to perform the first hashing operation and the second hashing operation comprise instructions operable to perform the first hashing operation and the second hashing operation such that a change in the first check value results in a corresponding change in the second check value and a change in the second check value results in a corresponding change in the first check value.

14. The computer readable storage media of claim 10, wherein the instructions operable to compute the first check value and the second check value comprise instructions operable to compute the first check value and the second check value by solving a set of linear equations comprising the first equation and the second equation.

15. The computer readable storage media of claim 14, wherein computing the first check value and the second check value by solving the set of linear equations comprises computing the first check value and the second check value by solving the set of linear equations, wherein the first equation and the second equation are dependent upon one another.

16. The computer readable storage media of claim 14, wherein the instructions operable to compute comprise instructions operable to compute the first check value and the second check value by solving the set of linear equations that are generated according to one of the following techniques: linear over addition in a Galois field of two elements (GF(2)), linear over addition modulo N, and linear over arithmetic in a Galois field with pⁿ elements (GF(pⁿ)).

17. The computer readable storage media of claim 10, further comprising instructions operable to repeat the computing of the first check value and the second check value after a predetermined amount of time to produce an updated first check value and an updated second check value.

18. The computer readable storage media of claim 10, further comprising instructions operable to identify the first portion of the instructions that is nonconsecutive with the second portion of the instructions.

19. An apparatus comprising:
a network interface unit;
a memory; and
a processor coupled to the network interface unit and the memory and configured to:
assign at least a first check point having a first check value and a second check point having a second check value within a plurality of instructions of a software program;
identify at least first and second portions of the instructions such that the first portion of the instructions comprises one or more check points other than the first check point and such that the second portion of the instructions comprises one or more check points other than the second check point;
perform a first hashing operation over the first portion resulting in a first equation and perform a second hashing operation over the second portion resulting in a second equation; and
compute the first check value and the second check value based on the first equation and the second equation.

20. The apparatus of claim 19, wherein the processor is further configured to compare the first check value with a predetermined stored first check value and compare the second check value with a predetermined stored second check value to generate comparison results; and
determine that the instructions have been tampered with when the comparison results indicate that either the first check value does not match the predetermined stored first check value or the second check value does not match the predetermined stored second check value.

21. The apparatus of claim 20, wherein the processor is further configured to determine the first predetermined stored check value based on an initial acceptable checksum value and the second predetermined stored check value based on an initial acceptable second checksum value.

22. The apparatus of claim 19, wherein the processor is further configured to perform the first hashing operation and the second hashing operation such that a change in the first check value results in a corresponding change in the second check value and a change in the second check value results in a corresponding change in the first check value.

23. The apparatus of claim 19, wherein the processor is further configured to compute the first check value and the second check value by solving a set of linear equations comprising the first equation and the second equation.
